(19) United States
(12) Patent Application Publication
(10) Pub. No.: US 2008/0026136 A1
(43) Pub. Date: Jan. 31, 2008

(54) Process for manufacture of ceramic capacitors using ink jet printing

(76) Inventors: Daniel J. Skamser, Simpsonville, SC (US); Michael S. Randall, Simpsonville, SC (US); J. Thomas Hochheimer, Greenville, SC (US); Azizuddin Tajuddin, Laurens, SC (US)

Correspondence Address: NEXSEN PRUET, LLC, P.O. BOX 10648, GREENVILLE, SC, 29603, US

(21) Appl. No.: 11/491,725

(22) Filed: Jul. 24, 2006

(51) Int. Cl. B05D 5/12; C03B 29/00; H01G 4/06

(52) U.S. Cl. 427/79; 156/89.12; 156/89.14; 427/123; 427/126.2; 361/321.3

(57) ABSTRACT

A process for forming a multilayer ceramic device. The device includes forming a ceramic precursor layer followed by ink jet printing in alternating order an electrode precursor in a predetermined pattern on the ceramic precursor layer to form an electrode and a ceramic ink on the electrode. The ceramic precursor is then sintered.

### BACKGROUND OF THE INVENTION

The present invention is related to an improved method for forming a multilayer device and a device formed thereby. More particularly, the present invention is related to the formation of a multilayer device by ink jet printing consecutive layers to form a multilayered device.

Manufacturing of multilayer devices by lamination is a standard practice particularly in the manufacture of multi-layer ceramic capacitors (MLCC). As with any electronic component the ongoing desire for miniaturization places continued burdens on every aspect of product properties and product manufacture thereby forcing those of skill in the art to continue to advance the art. It is highly desirable to increase the layer count while concurrently decreasing the layer thickness.

As layer counts in a multilayer device increase and as the dielectric and electrode thicknesses decrease the manufacturing difficulties increase. In particular, it becomes increasingly more difficult to manufacture a device with minimal layer distortion. Layer distortion is detrimental to the physical properties of the capacitor and is now realized to represent a significant cause of inferiority in capacitors. Past efforts to minimize physical distortion have involved optimization of the lamination time, temperature and pressure.

Through extensive research the ability to use lamination techniques has been extended to thin layers. Unfortunately, the continued desire for ever increasing miniaturization and increased capacitance per unit volume in modern day circuitry has now advanced beyond that which can be readily provided by lamination techniques.

There has been an ongoing desire in the art for a method of forming multilayer ceramic products with minimal distortion of the internal layers at layer thicknesses which are currently difficult to achieve. The present invention achieves these goals without the need for lamination.

### SUMMARY OF THE INVENTION

It is an object of the invention to provide a method for manufacturing multilayer ceramic components with minimal distortion of the individual layers.

It is another object of the invention to provide a method for manufacturing multilayer ceramic components with thin layers which are accurately and consistently applied.

It is another object of the invention to provide capacitors with thin layers for improved capacitance volume.

A particular feature of the present invention is avoidance of the use of transfer layers and elimination of the sequential lamination step typically employed in capacitor manufacture.

Another particular feature of the present invention is the ability to make via structures within the multilayer structure without the use of separate via punch and via fill processes.

Yet another feature of the present invention is the ability to provide a multilayer ceramic capacitor which can be incorporated into a discrete, array, embedded or other configuration.

These and other advantages, as will be realized, are provided in a process for forming a multilayer ceramic device. The device includes forming a ceramic precursor layer via any standard technique, including ink jet deposition, on a removable substrate, followed by ink jet printing in alternating order an electrode precursor in a predetermined pattern on the ceramic precursor layer to form an electrode and a ceramic ink on the electrode. The ceramic precursor is then sintered.

Another embodiment of the present invention is provided in a process for forming a multilayer ceramic capacitor. The process includes:
a) depositing a ceramic precursor on a support via any standard technique including ink jet printing;
b) ink jet printing an electrode precursor in a first predetermined pattern on the ceramic precursor;
c) ink jet printing a second ceramic precursor in a second predetermined pattern on the electrode layer;
d) repeating b) and c) until a predetermined number of layers is obtained;
e) removing the support; and
f) sintering the ceramic precursor.

Yet another embodiment is provided in a process for forming a multilayer ceramic capacitor. The process includes forming a ceramic precursor layer. An electrode ink is ink jet printed on the ceramic precursor layer to form a first electrode layer. A ceramic precursor ink is ink jet printed on the first electrode layer to form a first dielectric layer. An electrode ink is ink jet printed on the first dielectric layer to provide a second electrode layer, the first and second electrodes extending to external terminals in an interdigitated manner, forming a multilayer device structure.

### BRIEF DESCRIPTION OF FIGURES

FIG. 1 illustrates a capacitor in partial cut-away view.

FIG. 2 illustrates a preferred process of the present invention.

FIG. 3 illustrates a partial side view of an embodiment of the present invention.

FIG. 4 illustrates a top view of an embodiment of the present embodiment.

FIG. 5 illustrates a top view of an embodiment of the present embodiment.

FIG. 6 illustrates a side-view of an embodiment of the present invention.

FIG. 7 illustrates a cross-sectional side view of an embodiment of the present invention.

FIG. 8 illustrates a cross-sectional top view of an embodiment of the present invention.

### DETAILED DESCRIPTION

The instant invention will be described with reference to the various drawings forming an integral part of the specification. In the various drawings similar elements will be numbered accordingly.

An improved method for manufacturing a multilayer ceramic device is provided herein. The method includes applying consecutive layers of electrode and dielectric layers by ink jet printing techniques without reliance on transfer sheets for the layers.

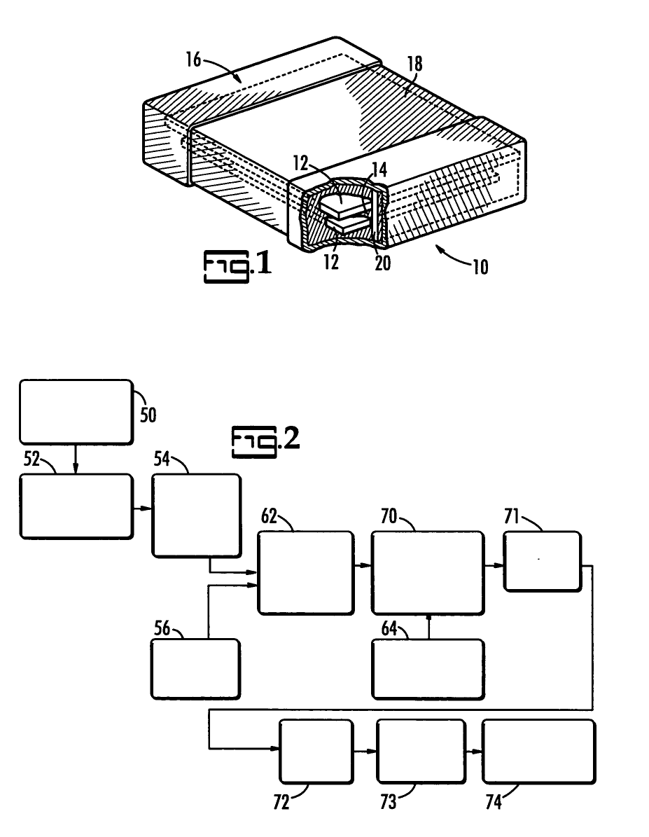

A multilayer ceramic device is illustrated in FIG. 1. In FIG. 1, the device, generally represented at 10, comprises internal electrodes, 12, with dielectric, 14, there between. As would be realized the plates are alternately in contact with external electrodes, 16, of opposite polarity. External electrodes are also referred to as terminations. A ceramic dielectric, 18, acts as a protective barrier. An internal layer, 20, facilitates electrical connectivity between the internal electrode and the external electrodes. Two plates are illustrated for clarity but it is understood that the number of alternate plates can be hundreds or thousands. In the example of FIG. 1 each electrode is continuous meaning there are no internal voids.

The internal electrodes and vias are one or more layer of conductive metal and are not particularly limited herein. The ceramic material is not particularly limiting herein, however, ceramics prepared by low-temperature sintering precursors or precursors which can be sintered in a non-oxidizing atmosphere are preferred. The internal electrode layer is preferably a nickel layer and the external electrode is preferably a combination of copper, nickel and tin to facilitate soldering.

The process for manufacturing a multilayer ceramic capacitor will be described with reference to FIG. 2.

In FIG. 2, a ceramic powder is prepared at 50. The ceramic powder comprises ceramic precursors, organic vehicle, coating aids, and other ingredients typically utilized in ceramic capacitor formation with the exceptions that the solvents (aqueous or organic), binders and modifiers (organic) materials utilized and formulations thereof are selected to optimize performance for ink jet deposition. The ceramic powder is thoroughly mixed as known in the art to form a ceramic precursor ink at 52. The ceramic precursor ink is applied to a substrate by ink jet printing techniques thereby forming a ceramic dielectric insulating layer at 54. In a parallel process the metal powders are prepared at 56. The metal powders are not particularly limited herein. The metal powders are incorporated into a matrix to form an electrode precursor ink which is then ink jet printed on the ceramic dielectric insulating layer at 62 in a predetermined pattern thereby forming a patterned sheet. A ceramic precursor ink is prepared at 64. The ceramic precursor ink is applied by ink jet printing techniques over the patterned dielectric insulating layer at 70. The ceramic precursor ink is preferably applied in the margin between the electrode deposits and as a layer over lapping the electrode precursor deposits thereby forming a relatively smooth layer as further described herein. In the case of internal via structures, the vias are formed by printing one or more electrically conducting layers through one or more dielectric insulating layers that have been patterned to accommodate the printed conductor. The via ink is conductive and is typically filled with a metal powder as well as shrinkage modifiers. The via composition is not particularly limited herein. A particular advantage of ink jet printing techniques is that the layer thickness can be accurately controlled within the layer thicknesses of interest herein. A second particular advantage is that the ink jet process easily accommodates pattern changes throughout the process so that electrode patterns, via structures and the like may be easily modified during fabrication of the multilayer device. This process is repeated until the predetermined number of alternating layers is obtained.

After the required number of layers are in place the layered structure is subjected to singulation at 72 and then subjected to a thermal process at 73 wherein the ceramic precursors are sintered and volatiles are removed, as well known in the art, to form a fired capacitor precursor. The fired capacitor precursor is finished at 74 wherein the corners are preferably rounded and the terminations are applied to form the finished capacitor.

The terminations may be applied by ink jet printing conductive, or ceramic precursor, layers into the appropriate locations either during the ink jet build up process by depositing termination precursors via ink jet as the multilayer devices is fabricated, or via ink jet deposition on the singulated multilayer devices as a post build up process. Ink jet deposition of terminations is preferable over the conventional dipping technique since the location and thickness of the deposited layers is more easily controlled by ink jet than it is by dipping.

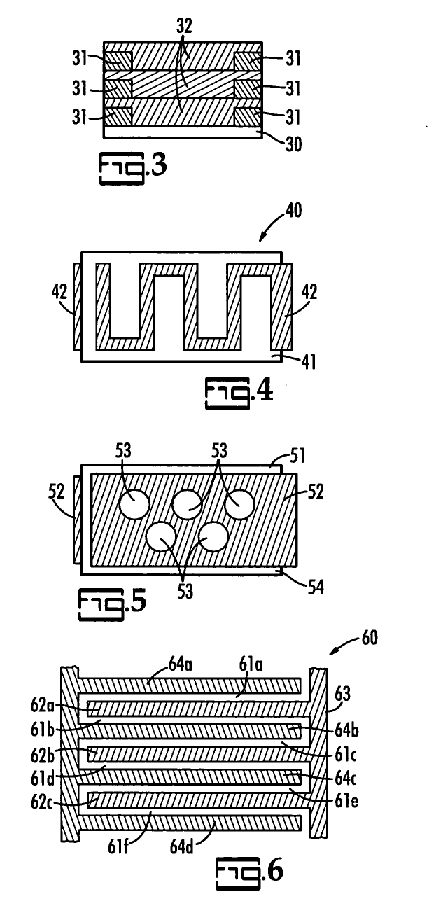

An embodiment of the present invention will be described with reference to FIG. 3. In FIG. 3, a substrate, 30, has electrodes, 31, printed thereon in a predetermined pattern. A dielectric precursor, 32, is printed over the electrodes and at least partially filling the margins between the electrodes. The electrodes and dielectric layers are printed sequentially until the desired number of layers is obtained.

The precursor for forming the dielectric layers can be obtained by mixing a raw dielectric material with either an organic or aqueous based vehicle. The raw dielectric material may be a mixture of oxides and composite oxides as previously mentioned. Also useful are various compounds which convert to such oxides and composite oxides upon firing. These include, for example, carbonates, oxalates, nitrates, hydroxides, sol gel and organometallic compounds. The dielectric material is obtained by selecting appropriate species from these oxides and compounds and mixing them. The proportion of such compounds in the raw dielectric material is determined such that after firing, the specific dielectric layer composition may be met. The raw dielectric material is generally used in powder form having a mean particle size of about 0.01 to about 1 μm, preferably about 0.03 to 0.5 μm.

A particular feature of ink jet printing is the ability to print patterns and the ability to change print patterns rapidly. The precision with which the layers can be applied by ink jet printing allows the electrode pattern and the dielectric pattern to be accurately defined, for each layer if desired, without changing the manufacturing process.

An embodiment of the present invention is illustrated in partial view in FIG. 4. In FIG. 4, a layered structure, 40, is illustrated comprising a dielectric layer, 41, which is substantially rectangular, between two electrode layers, 42. The electrode layers, 42, are patterned wherein at least a portion of the electrode deviates inwardly from rectangular. A particularly preferred embodiment is a serpentine electrode since this allows the equivalent series resistance (ESR) to be adjusted by parallel legs of the electrode.

Another embodiment of the present invention is illustrated in FIG. 5. In FIG. 5, a layered structure, 50, is illustrated comprising a dielectric, 54, between two electrode layers, 52. Each electrode layer has voids, 53, in the interior of the electrode layer. The voids can be optimized to control current flow through the layer for increased control of ESR and other properties. Each subsequent electrode layer may have the voids overlayed over the voids of the previous layer or each layer may have voids which are offset from the voids of previous or subsequent layers.

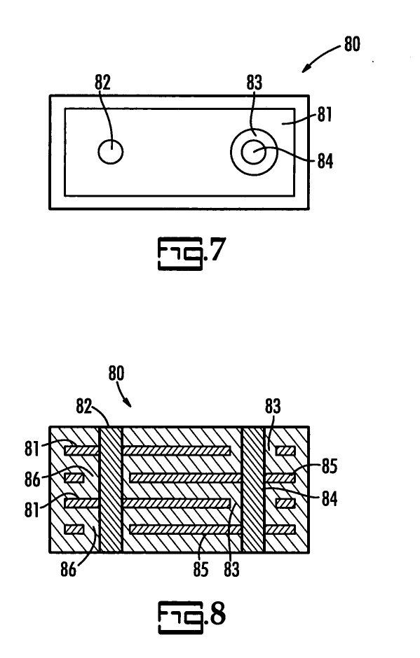

A particular advantage of the present invention will be described with reference to FIG. 6. A partial schematic cross-sectional view of a capacitive segment is illustrated in FIG. 6 at 60. The capacitive segment comprises alternating layers of electrodes, 62 and 64, of opposing polarity. Between each pair of electrodes is a dielectric layer, 61. The electrodes terminate in alternating fashion at terminations, 63 and 65, which ultimately are in electrical contact with external electrodes of opposing polarity. As each layer is printed the terminal end can also be printed thereby eliminating a step in the overall process. Focusing on dielectric layer 61f as an example and building upwards the next layer to be printed is electrode layer 62c terminating at 63. Electrode layer 62c is printed by ink jet and the spray continues around the end of the dielectric layer 61f to form the termination, 63, which is continuous with electrode layer 62c. Likewise, dielectric layer 61e would be printed by an ink jet printer to cover electrode 62c and continue around the right side of 62c to form the dielectric spacer between electrode 62c and termination 65. As each layer is printed the edge is printed to either overlap with the previously printed section of the appropriate termination, if an electrode layer, or to form a separation, if a dielectric layer. In a single printing pass the electrode layer is printed and that electrode is brought into electrical contact with the termination. Similarly, in a single printing pass the dielectric is printed as is the separation between the electrode and the termination of opposing polarity. This allows for rapid, accurate, buildup of capacitors without the necessity for additional steps to form the terminations.

An embodiment of the present invention is illustrated in cross-sectional top view in FIG. 7 and in cross-sectional side view in FIG. 8.

The capacitor, generally represented at 80, comprises alternating capacitor plates, 81 and 85. Each plate has a void, 83 and 86, wherein the void of alternating plates are aligned. A via, 82 and 84, passes through the voids to connect alternating plates. The via is then electrically connected to external termination and well known in the art.

The organic vehicle, or organic additive, is a binder in an organic or aqueous solvent. The binder used herein is not critical and may be suitably selected from one or more conventional binders such as ethyl cellulose, polyvinyl butyral (PVB), latex, polycarbonate, poly alkylene carbonate or the like. Also the solvent used herein is not critical and may be aqueous or one or more suitably selected from conventional organic solvents such as terpineol, butylcarbitol, ethers, glycol ethers, acetone, alcohol and toluene or combinations thereof in accordance with the particular application method.

The ceramic precursor is preferably selected from titanates such as barium titanate, strontium titanate, calcium titanate, magnesium titanate, zinc titanate, lanthanum titanate, neodymium titanate and lead titanate; zirconates such as barium zirconate calcium zirconate and lead zirconate; stannates, such as barium stannate and calcium stannate and combinations thereof. The ceramic is preferably spherical or rounded but can have irregular shapes. The particle size, as defined by D₅₀, is preferably in the range of 5% to 33% of the thickness of the fired dielectric layer or 1 nm to 1 μm. More preferably the particle size, D₅₀, is between 0.15 μm to 0.6 μm. The size distribution is defined such that the D₁₀ to D₉₀ is less than one order of magnitude or from about 50 nm to 500 nm. For the purposes of the present application D50 is the median diameter using light scattering techniques to measure the particle size. It is most preferred that the particles have a surface roughness (R_{z}) of less than 150 nm and more preferably less than 75 nm as measured by transmissive electron microscopy or atomic force measurements. Dopants may be included in the flowable ceramic such as lanthanides, magnesium, calcium or manganese.

The binder for the ceramic precursor ink is any suitable hydrocarbon capable of forming a matrix which can be volatilized. Particularly preferred binder materials include ethyl cellulose, polyvinyl butyral, acrylics, lattices polycarbonate, poly alkylene carbonate or the like and mixtures thereof. The binder and dielectric, or solids component of the precursor, preferably comprise about 1 to 50%, by volume, dielectric and 0.5 to 40%, by volume, binder. More preferably the total solids component comprises about 1.5 to 30%, by volume, dielectric and 0.2 to 10%, by volume, binder and about 1.0 to 29.5%, by volume, dielectric is preferred.

The solvent for the ceramic precursor ink is chosen for compatibility with the ink jet printing process, the drying rate and manufacturing or environmental concerns. The solvent may be aqueous or organic or a combination thereof.

Particularly preferred solvents include terpineols, polyethylene glycol, glycols, glycol ethers, water, polyethylene glycol, butyl cellosolve, acetone, alcohols, pine oils, mineral oils, menthols, vegetable oils, toluene, terpineols and alcohols or a combination thereof. Most preferably, the solvent system is either a material with a low vapor pressure. The viscosity of the preferred ink should not exceed 50 centipoise, more preferably the viscosity of the preferred ink is less than 15 centipoise and most preferably less than 5 centipoise. The surface tension of the preferred ink should not exceed 50 dyne-cm, more preferably 25 dyne-cm and most preferably 20 dyne-cm.

The ceramic precursor ink may further comprise additional adjuvants including dispersants; surfactants; rheology modifiers; adhesion adjusters such as tackifiers, Santicizer S-160 and Abitol; HC resins such as Escorez; rosins and acrylics; shrinkage adjusters such as sintering aids, glasses, oxides or refractory additives; flow enhancers such as phthalates, particularly butyl benzyl phthalates, dioctyl phthalates and dibutyl phthalates; and adipates as appropriate.

The electrode precursor ink for forming the internal electrode layers is obtained by mixing an electro-conductive material with either an organic or aqueous solvent vehicle. The conductive material used herein includes conductors such as conductive metals and alloys as mentioned above and various compounds which convert into such conductors upon firing, for example, oxides, organometallic compounds and resonates, conductive ceramics such as superconducting materials and the like. The organic vehicle is as mentioned above.

Ink for forming external electrodes is preferably prepared by the same method as the internal electrode layer-forming ink with the exception that the rheology of the system may be modified suitably for application of the required external film properties.

No particular limit is imposed on the organic vehicle content of the respective inks mentioned above. Often the ink contains about 0.1 to 5 wt % of the binder and about 1 to 50 wt % of the conductor or conductor precursor mixed in the solvent. If desired, the respective inks may contain any other additives such as dispersants, plasticizers, dielectric compounds, and insulating compounds. The total content of these additives is preferably up to about 10 wt %.

The dielectric layers may have an appropriate Curie temperature which is determined in accordance with the applicable standards by suitably selecting a particular composition of dielectric material. Typically the Curie temperature is typically, but not necessarily, higher than 45° C., and typically about 65° C. to 125° C.

Each dielectric layer preferably has a thickness of up to about 10 μm, more preferably up to about 2 μm. The lower limit of thickness is about 0.005 to 0.5 μm, preferably about 0.05 to 0.3 μm. The number of dielectric layers stacked is generally from 100 to over 3,000, preferably from 200 to about 2,000.

A particularly preferred ceramic comprises barium titanate, barium strontium titanate or barium strontium zirconium titanate at up to about 90 wt % with any of the lanthanides (Y, Er, Yb, Dy, Ho) as dopants at up to about 3 wt %; either Mg, Ca, or Mn or a combination thereof at no more than about 2 wt % and fluxing agent, such as a silicate glass at no more than about 6 wt %.

The heating rate is preferably about 1 to 300° C./hour, more preferably 3 to 100° C./hour. The first holding temperature is preferably about 200 to 400° C., more preferably 250 to 300° C. The holding time is preferably about ½ to 100 hours, more preferably 5 to 20 hours. The atmosphere is preferably non-oxidizing such as a wet atmosphere with less than 3% oxygen when using a base metal electrode system and compatable dielectric. The green chip is then fired in an atmosphere with an oxygen partial pressure of 10⁻⁵ to 10⁻¹⁸ atm. Extremely low oxygen partial pressure should be avoided, since at such low pressures the conductor can be abnormally sintered and may become disconnected from the dielectric layers. At oxygen partial pressures above the range, the internal electrode layers are likely to be oxidized.

For firing, the chip preferably is held at a temperature of 700° C. to 1,400° C., more preferably 800 to 1,200° C. Lower holding temperatures below the range would provide insufficient densification whereas higher holding temperatures above the range can lead to poor DC bias performance or to delamination. Remaining conditions for sintering preferably are as follows. Heating rate: 5 to 500° C./hour, more preferably 20 to 300° C./hour. The holding time is preferably about ½ to 8 hours, more preferably 0.5 to 5 hours. The cooling rate is preferably about 5 to 500° C./hour, more preferably 20 to 300° C./hour. The firing atmosphere preferably is a reducing atmosphere. An exemplary atmospheric gas is a humidified mixture of N₂ and H₂ gases with H₂ content of less than 8%.

Firing of the capacitor chip in a reducing atmosphere preferably is followed by annealing. Annealing is effective for re-oxidizing the dielectric layers, thereby optimizing the resistance of the ceramic to dielectric breakdown or degradation in insulation resistance over time. The annealing atmosphere may have an oxygen partial pressure of at least 10⁻¹ to 10⁻¹⁰ atm., preferably 10⁻⁵ to 10⁻⁴ atm. The dielectric layers are not sufficiently re-oxidized at a low oxygen partial pressures below the range, whereas the internal electrode layers are likely to be oxidized at oxygen partial pressures above this range.

For annealing, the chip preferably is held at a temperature of lower than 800° C., more preferably 400° C. to 1,100° C. Lower holding temperatures below the range would oxidize the dielectric layers to a lesser extent, thereby leading to a shorter life. Higher holding temperatures above the range can cause the internal electrode layers to be oxidized (leading to a reduced capacitance) and to react with the dielectric material (leading to a shorter life). Annealing can be accomplished simply by heating and cooling. In this case, the holding temperature is equal to the highest temperature on heating and the holding time is zero.

Remaining conditions for annealing preferably are as follows. The holding time is preferably about 0 to 20 hours, more preferably 2 to 10 hours. The cooling rate is preferably about 20 to 500° C./hour, more preferably 50 to 300° C./hour.

The preferred atmospheric gas for annealing is humid nitrogen gas. The nitrogen gas or a gas mixture used in binder removal, firing, and annealing, may be humidified using a wetter. In this regard, water temperature preferably is about 5 to 75° C.

The binder removal, firing, and annealing may be carried out either continuously or separately. If done continuously, the process includes the steps of binder removal, changing only the atmosphere without cooling, raising the temperature to the firing temperature, holding the chip at that temperature for firing, lowering the temperature to the annealing temperature, changing the atmosphere at that temperature, and annealing.

If done separately, after binder removal and cooling down, the temperature of the chip is raised to the binder-removing temperature or higher in dry or humid nitrogen gas to remove residual carbon. The atmosphere then is changed to a reducing one, and the temperature is further raised for firing. Thereafter, the temperature is lowered to the annealing temperature and the atmosphere is again changed to dry or humid nitrogen gas, and cooling is continued. Alternately, once cooled down, the temperature may be raised to the annealing temperature in a nitrogen gas atmosphere. The entire annealing step may be done in a humid nitrogen gas atmosphere.

The resulting chip, if not terminated during the build-up process, may be polished at end faces by barrel tumbling and sand blasting, for example, before the external electrode-forming paste is printed or transferred, via either ink jet printing or other method, and baked to form external electrodes. Firing of the external electrode-forming paste may be carried out under the following conditions: a humid mixture of nitrogen and hydrogen gases, about 500 to 900° C., and about 3 minutes to about 1 hour.

The multilayer ceramic chip capacitors of the invention can be mounted on printed circuit boards, for example, by soldering.

The ink jet printing method is preferably selected from piezoelectric, bubble jet, arrayer and continuous methods. Piezoelectric methods are most preferred due to the improved ability to control the quality and quantity of the printing.

The present invention has been described with particular reference to the preferred embodiments without limit. It would be apparent to one of skill in the art, based on the description herein, that alternate embodiments could be envisioned without departing from the scope of the invention which is specifically set forth in the claims appended hereto.

1. A process for forming a multilayer ceramic device comprising:
forming a ceramic precursor layer;
ink jet printing in alternating order an electrode precursor in a predetermined pattern on said ceramic precursor layer to form an electrode and a ceramic ink on said electrode; and
sintering said ceramic precursor.

2. The process for forming a multilayer ceramic device of claim 1 further comprising ink jet printing terminations in electrical contact with alternating electrodes.

3. The process for forming a multilayer ceramic device of claim 2 wherein said ink jet printing terminations is done in a printing pass with said ink jet printing an electrode precursor.

4. The process for forming a multilayer ceramic device of claim 1 wherein said ceramic ink is in contact with a previous ceramic ink.

5. The process for forming a multilayer ceramic device of claim 1 wherein each said electrode is continuous.

6. The process for forming a multilayer ceramic device of claim 1 wherein at least one said electrode comprises voids.

7. The process for forming a multilayer ceramic device of claim 1 wherein more than one said electrode is interconnected by an electrically conducting via.

8. The process for forming a multilayer ceramic device of claim 1 wherein at least one said electrode is connected to the exterior of the device by an electrically conducting via.

9. The process for forming a multilayer ceramic device of claim 1 wherein more than one said electrode is interconnected by a thermally conducting via.

10. The process for forming a multilayer ceramic device of claim 1 wherein at least one said electrode is connected to the exterior of the device by a thermally conducting via.

11. The process for forming a multilayer ceramic device of claim 1 wherein more than one said electrode is interconnected by a resistor, inductor or semiconductor via.

12. The process for forming a multilayer ceramic device of claim 1 wherein at least one said electrode is connected to the exterior of the device by a resistor, inductor, or semiconductor via.

13. The process for forming a multilayer ceramic device of claim 1 wherein at least one said electrode is patterned.

14. The process for forming a multilayer ceramic device of claim 13 wherein at least one said electrode is serpentine.

15. A capacitor formed by the method of claim 1.

16. A process for forming a multilayer ceramic capacitor comprising:
a) depositing a ceramic precursor on a support;
b) ink jet printing an electrode precursor in a first predetermined pattern on said ceramic precursor;
c) ink jet printing a second ceramic precursor in a second predetermined pattern on said electrode layer;
d) repeating b) and c) until a predetermined number of layers is obtained;
e) removing said support; and
f) sintering said ceramic precursor.

17. The process for forming a multilayer ceramic device of claim 16 further comprising ink jet printing terminations in electrical contact with alternating electrodes.

18. The process for forming a multilayer ceramic device of claim 16 wherein said ink jet printing terminations is done in a printing pass with said ink jet printing an electrode precursor.

19. The process for forming a multilayer ceramic device of claim 16 wherein said ceramic ink is in contact with a previous ceramic ink.

20. The process for forming a multilayer ceramic device of claim 16 wherein each said electrode is continuous.

21. The process for forming a multilayer ceramic device of claim 16 wherein at least one said electrode comprises voids.

22. The process for forming a multilayer ceramic device of claim 16 wherein at least one said electrode is patterned.

23. The process for forming a multilayer ceramic device of claim 16 wherein more than one said electrode is interconnected by a thermally conducting via.

24. The process for forming a multilayer ceramic device of claim 16 wherein at least one said electrode is connected to the exterior of the device by a thermally conducting via.

25. The process for forming a multilayer ceramic device of claim 16 wherein more than one said electrode is interconnected by a resistor, inductor or semiconductor via.

26. The process for forming a multilayer ceramic device of claim 16 wherein at least one said electrode is connected to the exterior of the device by a resistor, inductor, or semiconductor via.

27. The process for forming a multilayer ceramic device of claim 16 wherein at least one said electrode is serpentine.

28. A capacitor formed by the process of claim 16.

29. A process for forming a multilayer ceramic capacitor comprising:
forming a ceramic precursor layer;
ink jet printing an electrode ink on said ceramic precursor layer to form a first electrode layer;
ink jet printing a ceramic precursor ink on said first electrode layer to form a first dielectric layer;
ink jet printing an electrode ink on said first dielectric layer and beyond an edge of said first dielectric layer to be in electrical contact with said first electrode layer thereby forming a second electrode layer;
ink jet printing a ceramic precursor ink on said second electrode layer and beyond an edge of said second electrode layer to contact said first dielectric layer.

30. The process for forming a multilayer ceramic device of claim 29 further comprising ink jet printing terminations in electrical contact with alternating electrodes.

31. The process for forming a multilayer ceramic device of claim 30 wherein said ink jet printing terminations is done in a printing pass with said ink jet printing an electrode precursor.

32. The process for forming a multilayer ceramic device of claim 29 wherein said ceramic ink is in contact with a previous ceramic ink.

33. The process for forming a multilayer ceramic device of claim 29 wherein each said electrode is continuous.

34. The process for forming a multilayer ceramic device of claim 29 wherein at least one said electrode comprises voids.

35. The process for forming a multilayer ceramic device of claim 29 wherein at least one said electrode is patterned.

36. The process for forming a multilayer ceramic device of claim 29 wherein more than one said electrode is interconnected by a thermally conducting via.

37. The process for forming a multilayer ceramic device of claim 29 wherein at least one said electrode is connected to the exterior of the device by a thermally conducting via.

38. The process for forming a multilayer ceramic device of claim 29 wherein more than one said electrode is interconnected by a resistor, inductor or semiconductor via.

39. The process for forming a multilayer ceramic device of claim 29 wherein at least one said electrode is connected to the exterior of the device by a resistor, inductor, or semiconductor via.

40. The process for forming a multilayer ceramic device of claim 29 wherein at least one said electrode is serpentine.

41. A capacitor formed by the method of claim 29.
